(19) United States
(12) Patent Application Publication
(10) Pub. No.: US 2015/0052589 A1
(43) Pub. Date: Feb. 19, 2015

(54) APPARATUS FOR PROCESSING IMAGE, METHOD FOR PROVIDING PERSONALIZATION SERVICE, AND COMPUTER-READABLE MEDIUM

(71) Applicant: SAMSUNG ELECTRONICS CO., LTD., Suwon-si (KR)

(72) Inventors: Bong-gil BAK, Suwon-si (KR); Min-seok KIM, Suwon-si (KR); Jong-ho YANG, Yongin-si (KR)

(73) Assignee: SAMSUNG ELECTRONICS CO., LTD., Suwon-si (KR)

(21) Appl. No.: 14/338,938

(22) Filed: Jul. 23, 2014

(30) Foreign Application Priority Data
Jul. 31, 2013 (KR) 10-2013-0091033

(51) Int. Cl. H04L 29/06; H04L 9/14

(52) U.S. Cl. CPC H04L 63/10; H04L 9/14
USPC 726/4

(57) ABSTRACT

The disclosure relates to an image processing apparatus, a method for providing personalization service, and a computer-readable medium. An image processing apparatus according to an exemplary embodiment may include a data parsing unit configured to, by using an apparatus information and a user information obtained from a peripheral user apparatus, parse a security information requiring security from among the user information to a plurality of security information; an interface configured to divide and provide the plurality of parsed security information to at least one apparatus among the user apparatus and an external apparatus; and a personalization service unit configured to, when a personalization service of the user apparatus is requested, perform authorization of the user apparatus by receiving the security information divided and provided from the at least one apparatus, and provide the personalization service to the user apparatus according to an authorization result.

### CROSS-REFERENCE TO RELATED APPLICATION(S)

This application claims priority from Korean Patent Application No. 10-2013-0091033, filed on Jul. 31, 2013, in the Korean Intellectual Property Office, the disclosure of which is incorporated herein by reference in its entirety.

### BACKGROUND

1. Field

Aspects of the exemplary embodiments relate to an image processing apparatus, a method for providing personalization service, and a computer-readable recording medium, more particularly to an image processing apparatus which maintains security of user information obtained from a peripheral user device, such as a mobile phone, at an optical recording display apparatus, such as a Bluray player, and provides a customized service to customers, a method for providing personalization service where the service is personalized for the user, and a non-transitory computer-readable recording medium.

2. Description of the Prior Art

Recently, interworking technology between a private mobile device and a device mount terminal, such as, a TV and a set-top box (STB), has been introduced. In particular, amid an explosive increase in available content such as an image, sound, and application programs, the importance of a personalization service has been gaining more attention, as the service not only performs its original function to display a content selected by a user, but also automatically recommends a content suitable to a customer from among too much information, and intelligently adjusts a service scenario based on a preference of a user.

In order to maximize advantages of the personalization service, the operations to collect and manipulate useful user information are essentially required. Meanwhile, such user's private information is useful, and at the same time involves a sensitive issue of privacy. A user has contradictory needs—pursuing the convenience of the personalization service and feeling reluctant or unhappy when the user's important personal information is exposed externally.

Therefore, in order to address the privacy issue, provide a user with the convenience of the personalization service, and provide a service providing apparatus with enough personal information so as to operate the personalization service efficiently, intensifying a security of user information on the personalization service system is required.

### SUMMARY

An aspect of the exemplary embodiments is designed in accordance with the above-described necessities and is purposed to provide an image processing apparatus which provides a service customized to or personalized for a user by maintaining security of user information obtained from a peripheral device, such as a mobile phone, from an optical recording display apparatus, such as Bluray, a method for providing personal service, and a computer-readable recording medium.

An image processing apparatus according to an exemplary embodiment includes a data parsing unit configured to, by using apparatus information and user information obtained from a peripheral user apparatus, parse security information requiring security from among the user information into a plurality of security information; an interface configured to divide and provide the plurality of parsed security information to at least one apparatus among the user apparatus and an external apparatus; and a personalization service unit configured to, when a personalization service of the user apparatus is requested, perform authorization of the user apparatus by receiving the security information divided and provided from the at least one apparatus, and provide the personalization service to the peripheral user apparatus according to an authorization result.

The interface may include an encoder/decoder which encodes and decodes the security information, where the plurality of parsed data or parsed security information may be encoded security information.

The plurality of parsed data may include data related to at least one algorithm used for the encoding and decoding.

An algorithm for the encoding may read and find information on a file system which manages operations of the personalized service.

The apparatus may further include a storage configured to store a part of the plurality of parsed data, wherein a part of the plurality of parsed data stored in the storage may be deleted according to a request of the user apparatus.

The interface may be connected to an image display apparatus which displays a content requested by a user, where the apparatus information and the user information may be obtainable when the content is displayed on the image display apparatus.

A method for providing a personalization service includes parsing security information requiring security from among user information into a plurality of security information, by using apparatus information and user information obtained from a peripheral user apparatus; and when a personalization service of the user apparatus is requested, performing authorization of the user apparatus by receiving the security information divided and provided from the at least one apparatus and providing the personalization service to the peripheral user apparatus according to an authorization result.

The parsing a plurality of security information may include encoding and decoding the security information, wherein the plurality of parsed data is encoded security information.

The plurality of parsed data may include data related to at least one algorithm used for the encoding and decoding.

An algorithm for the encoding may include reading and finding information on a file system which manages operations of the personalized service.

The method may further include storing a part of the plurality of parsed data; and deleting a part of the plurality of parsed data stored in the storage according to a request of the user apparatus.

The apparatus information and the user information may be obtainable when the content is displayed on an image display apparatus.

In a non-transitory computer-readable medium to execute a method for providing a personalized or personalization service according to an exemplary embodiment includes a method of providing the personalization service comprising: parsing security information requiring security from among user information into a plurality of security information, by using apparatus information and user information obtained from a peripheral user apparatus; dividing and providing the parsed plurality of security information to at least one apparatus among the user apparatus and an external apparatus; and when a personalization service of the user apparatus is requested, performing authorization of the user apparatus by receiving the security information divided and provided from the at least one apparatus and providing the personalization service to the peripheral user apparatus according to an authorization result.

According to an exemplary embodiment, an image processing apparatus which is customized to a user, a method for providing personalization service, and a computer-readable recording medium can be provided, while protecting privacy of users who use an apparatus such as Bluray player.

### BRIEF DESCRIPTION OF THE DRAWINGS

The above and/or other aspects of the present concept will be more apparent by describing certain exemplary embodiments of the present concept with reference to the accompanying drawings, in which:

FIG. 1 is a view illustrating a personalization service system according to an exemplary embodiment.

FIG. 2 is a view illustrating an apparatus stored in an image processing apparatus of FIG. 1 and user information.

FIG. 3 is a detailed view illustrating an apparatus of FIG. 2 and user information.

FIG. 4 is a block diagram illustrating a structure of an image processing apparatus of FIG. 1.

FIG. 5 is a view illustrating a personalization service process according to the first exemplary embodiment.

FIG. 6 is a view illustrating a personalization service process according to the second exemplary embodiment.

FIG. 7 is a flow chart illustrating a method of providing a personalization service according to an exemplary embodiment.

### DESCRIPTION OF THE PREFERRED EMBODIMENT

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the application with unnecessary detail.

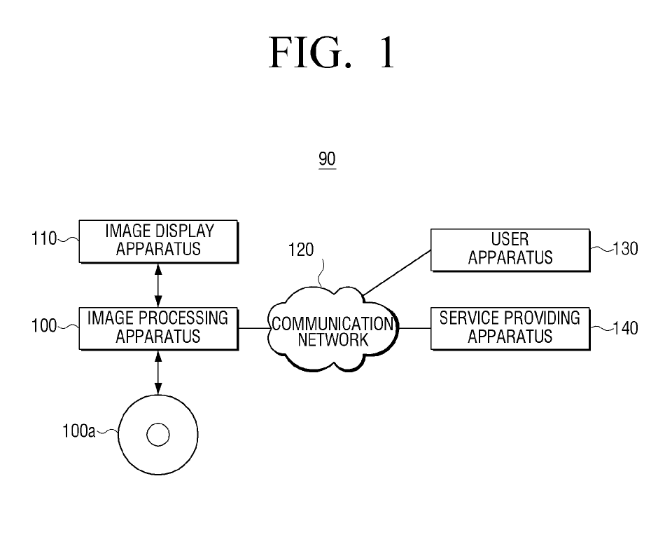

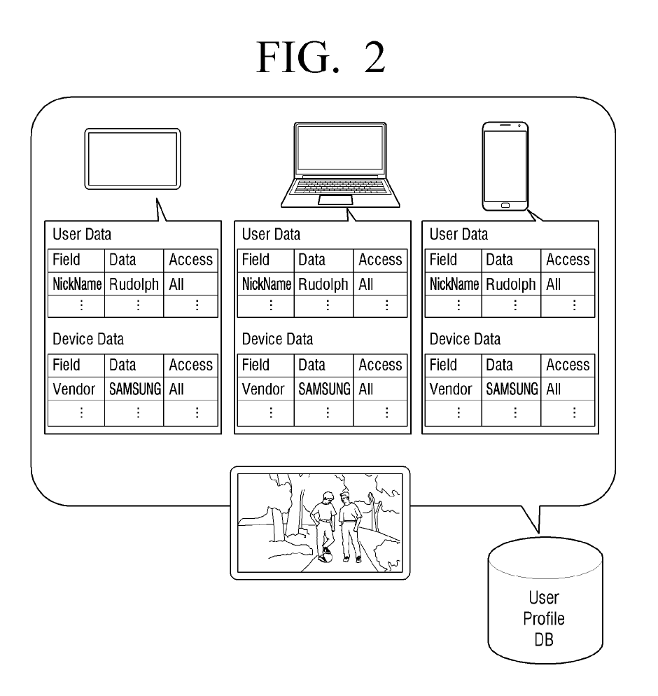

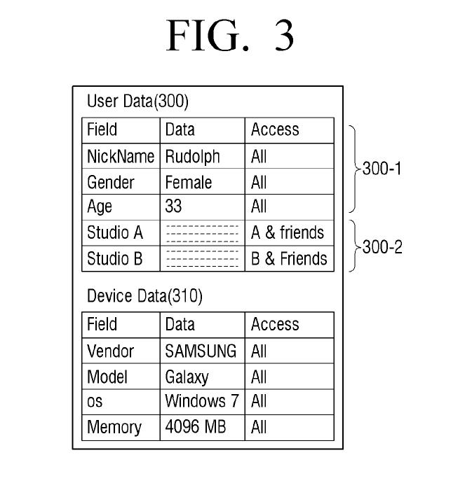

FIG. 1 is a view illustrating a personalization service system according to an exemplary embodiment, FIG. 2 is a view illustrating an apparatus stored in an image processing apparatus of FIG. 1 and user information, and FIG. 3 is a detailed view illustrating an apparatus of FIG. 2 and user information.

As illustrated in FIG. 1, a personalization service system 90 according to an exemplary embodiment may include a part or whole of an image processing apparatus 100, an image display apparatus 110, a communication network 120, a user apparatus 130, and a service providing apparatus 140.

Herein, including a part or whole indicates omitting of a part of the elements such as a service providing apparatus 140, or incorporating a part of the elements such as the image processing apparatus 100 into another element such as the image display apparatus 110. To facilitate understanding, it will be explained that exemplary embodiments include the whole of the above.

The image processing apparatus 100 may include an optical record display apparatus, such as a DVD and a Bluray player, which display a content stored in an optical disk 100a, and further include a set-top box and a game machine. The image processing apparatus 100 may be a standard type terminal apparatus which is composed or provided separately from the image display apparatus 110 and located in a certain place. The image processing apparatus 100 has a user profile DB which is illustrated in FIG. 2.

In a user profile DB, all the user profile information of the user apparatus 130 connectable to a network is stored. The user profile of the user apparatus 130, as illustrated in FIG. 3, includes a user data 300 and an apparatus data. Each user profile record of a user profile DB is stored (or indexed) by matching user information and apparatus information one by one, and user information may be divided into general user information with lower security and security information with higher security, and be stored. Furthermore, a user name may be stored in general user information as an anonymous name, and a user's gender as well as age can be stored arbitrarily. Moreover, when a user refuses to input a specific field among general user information, this field can be left in blank.

According to FIGS. 2-3, further referring to the user profile, the user data 300 may be divided into one or more security information, which is encrypted by an arbitrary algorithm, by a person who provides general user information such as a name, gender, age of a user and services thereof. General user information is information arbitrarily input by a user and is provided to the image processing apparatus 100. Thus, its accuracy is not guaranteed, and sometimes information can be omitted. Meanwhile, this lower security information is readable by everyone, and thus can be utilized to provide a personalization service at a beginner level in a user scenario with a lower security level. In addition, the apparatus data 310 includes information (see FIG. 3) such as a vendor, a model, OS, a memory size, and so on, and is helpful in selectively applying a service or a service scenario suitable for the user apparatus 130 in the process where the image processing apparatus 100 interacts with the user apparatus 130.

In addition, there is a program inside the image processing apparatus 100, which performs communication with the user apparatus 130 and the service providing apparatus 140 at a distant location through the communication network 120. The image processing apparatus 100, when detecting the user apparatus 130 on a network, may find out the corresponding records of the user apparatus 130 by searching a user profile DB within the image processing apparatus 100, and can transmit the result thereof to a predetermined interface, for example, a specific program which is executed on the image processing apparatus 100 under a control of the controller. In this case, in the process of transmitting a searched record to a program, a callback method can be utilized. In other words, a separate response for the transmitted record can be received.

The image processing apparatus 100 can largely provide (1) apparatus operation recognition, (2) security information protection, (3) personalization service, and (4) multi platform link service, etc. First of all, for automatic apparatus recognition, the image processing apparatus 100, while an internal program is activated, at the very moment when the user apparatus 130 activates network connection with the image processing apparatus 100, notifies about connection of a new user apparatus 100 to a program in the image processing apparatus 100 according to a predetermined protocol. A program of the image processing apparatus 100 which receives this message acquires user profile information of the user apparatus 130 which is connected through the API (Application Program Interface) determined by the image processing apparatus 100. In addition, by analyzing the obtained user data 300 and the apparatus data 310 in FIG. 3, user information and apparatus information are obtained.

In addition, the image processing apparatus 100, for protecting security information, can be interlinked with at least one of the user apparatus 130 and the service providing apparatus 140. A part of the programs in the image processing apparatus 100 can be distributed by a certain service providing apparatus. The program in the corresponding image processing apparatus 100 extracts security information in the user data 300 by using an algorithm designated by a service providing apparatus. In this case, position or location of algorithm can be found out by reading information in a file system which manages operations of the personalization service. For example, the position can be found through a file name or address information. In security information, sensitive information, such as credit card information, log-in ID, password, etc., can be recorded. Meanwhile, another service providing apparatus has no idea about the algorithm which processes the corresponding security information, the service providing apparatus may read the corresponding data but may not understand information within the data.

The image processing apparatus 100 can encode and decode security information. In the process of encoding/decoding, when a hand-shaking operation is involved in the image processing apparatus 100 and the user apparatus 130, an additional increase in security level is expected. Herein, hand-shaking is similar to the concept of sharing a nuclear missile button between the US President and Defense Minister. A part of security information is stored in the image processing apparatus 100, and a part of the rest is stored in the user apparatus 100. Therefore, by preventing extraction of sensitive security information by the image processing apparatus 100 alone, without assistance of the user apparatus 130, a security maker can access security information only when the attacker performs hacking the image processing apparatus 100 and the user apparatus 130 at the same time. Meanwhile, in another approach to enhance security, execution of the security algorithm between the image processing apparatus 100 and the user apparatus 130 can be shared, so that two independent algorithms located in both apparatuses can perform decoding based on mutual cooperation, making hacking more difficult. Of course, a method to apply data to the above-mentioned data segmentation and algorithm segmentation at the same time is available. As a method to further intensify the security level, a method to segment encrypted data into three parts and store the data in the image processing apparatus 100, the user apparatus 130, and the service providing apparatus 140 respectively is also available. Meanwhile, it is also possible to perform encoding and decoding by interlinking 3 independent algorithms in the image processing apparatus 100, the user apparatus 130, and the service providing apparatus 140. Lastly, there may be another method of encoding and decoding of security information by realizing 3 segmented security data and 3 independent algorithms in the image processing apparatus 100, the user apparatus 130, and the service providing apparatus 140 respectively, and performing encoding/decoding through the combination of them.

For the personalization service, the program in the image processing apparatus 100 which extracts general user information (300_1) and security information (300_2) within user data 300 can utilize the corresponding information and perform automatic access to a determined internet site[automatic input of ID and password], adjustment of UI (User Interface) message to correspond to a user's age and gender, restoration of the last service session of the same user, customized advertisement, recommendation, automatic setting based on a user's information already input. In addition, in accordance with the specification of the accessed user apparatus 130, customized services, such as adjusting a service scenario and deciding types of programs related to the user apparatus 130, can be provided.

Furthermore, the image processing apparatus 100, to provide multi-platform interlink service, can provide at least one application execution environment. For example, in a multi optical display recording apparatus which combines functions of a Bluray player and DTV, the corresponding apparatus may have BD-Java application execution environment and an ATSC (Advanced Television System Committee) application execution environment. Meanwhile, when a certain Bluray application creator and an ATSC service providing apparatus are allied, sharing technology on security information processing between two users is available. In a case of sharing a security algorithm, sharing security information is available. Through such information sharing, a scenario involving linkage service between heterogeneous types of platforms can be developed. As an example of a linkage service between heterogeneous types of platforms, information on user's preference collected through a pattern of viewing a Bluray movies can be provided to an ATSC data broadcasting application and be utilized in recommending real-time broadcasting program which are suitable for the corresponding user's preference.

Moreover, the image processing apparatus 100 can perform operations to discard the user data 300. When security information (300_2) within the user data 300 is deleted, sensitive user information provided to the existing service providing apparatuses can be deleted from the system. As the security information (300_2) is not provided to an end or a side of the service providing apparatus 140, a user can confirm that his/her sensitive personal information is safely discarded by deleting security information (300_2) of the image processing apparatus 100. For example, the user apparatus 130 can know about this in a message type.

The image display apparatus 110 displays an image which is interlinked to the image processing apparatus 100 and processed by the image processing apparatus 100 on a screen. For example, when a disk (100a) is inserted in the image processing apparatus 100, the image processing apparatus 100 reads data in the disk (100a), processes and decodes the read data for attributes of the data, and then outputs the data to the image display apparatus 110, the image display apparatus 110 enables a user to view a content, such as a movie, through a screen.

The communication network 120 includes both a wire type communication network and wireless type communication network. Herein, the wire type communication network includes an internet network such as a cable network or PSTN, the wireless communication network includes CDMA, WCDMA, GSM, EPC (Evolved Packet Core), LTE (Long Term Evolution), and WiBro network, etc. Accordingly, in the case when the communication network 120 is the wire type communication network, an access point can access to a telephone exchange of a telephone station, but in case of wireless communication network, data can be processed by accessing SGSN or GGSN (Gateway GPRS Support Node) operated by a telecommunication firm, or by accessing various telephone repeaters such as BTS (Base Station Transmission), NodeB, and e-NodeB.

In addition, the communication network 120 includes an AP (Access Point), such as Femto or Pico station, which is largely installed in a building. Herein, the Femto or Pico station is categorized depending on how many user apparatuses 130 can be accessed at the maximum. Of course, the AP includes a short distance communication module to perform short distance communication, such as the user apparatus 130, ZigBee, and Wi-Fi, etc. Short-distance communication in the exemplary embodiment can be implemented in various ways including RF (Radio Frequency) such as Bluetooth, ZigBee, infrared rays (IrDA), UHF (Ultra High Frequency), and VHF (Very High Frequency), and UWB (Ultra Wide Band) in addition to Wi-Fi. Accordingly, the AP can extract a position of data packet, designate the optimal communication path based on the extracted position, and transmit the data packet to a next apparatus, for example, the user apparatus 130 according to the designated communication path.

The user apparatus 130 is a hand-held apparatus capable of displaying an image such as a cell phone, a notebook, and a DMB. Such user apparatus 130 can include a communication module which can access the AP within the communication network 120 and communicate with the image processing apparatus 100. For example, when the image processing apparatus 100 is operated and an image is displayed on the image display apparatus 110, the user apparatus 130, when in a communication area of the AP, or through a separate access process, can be connected to the image processing apparatus 100. In the case of the initial access, a separate registration procedure may be required, but other than the initial access, a separate authentication process only can be performed.

The user apparatus 130 provides the image processing apparatus 100 with user information on a user, and a part of the security information from among the provided user information, can be provided from the image processing apparatus 100 again. This is to intensify security of user information. In this case, security information can be encrypted and provided. Along with this, as for an algorithm which encodes/decodes security information, the user apparatus 130 can divide and store a part of an execution unit corresponding to a filename extension (.exe). Afterwards, the user apparatus 130, upon repeated request of the personalization service, can provide security information stored inside, more accurately, encrypted information, or an algorithm so as to receive normal service after user authentication.

The service providing apparatus 140 is a kind of a server. The service providing apparatus 140 provides a specialized service to a user who uses the user apparatus 130. To do this, the service providing apparatus 130, when a user of the user apparatus 130 consented, can receive information on users from the image processing apparatus 100. Thereafter, the service providing apparatus 140 can provide specialized information for example, content, advertisement information, recommended information, by utilizing user information.

As a result of the above, the exemplary embodiments can provide the personalization service customized to a user while minimizing a privacy issue. In addition, the exemplary embodiments can give satisfaction to the service providing apparatuses through the efficient personalization service.

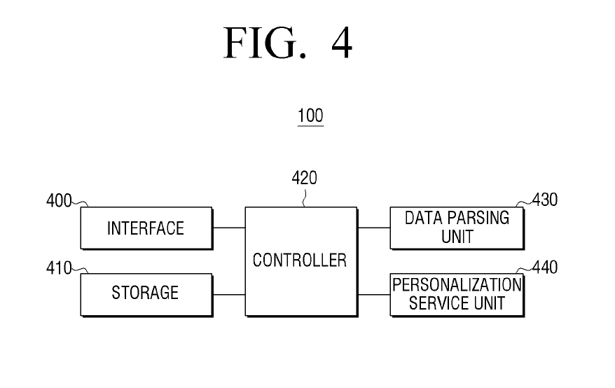

FIG. 4 is a block diagram illustrating a structure of an image processing apparatus of FIG. 1.

Referring to FIG. 4 along with FIG. 1, the image processing apparatus 100 according to an exemplary embodiment, includes a part or whole of the interface 400, the storage 410, the controller 420, the data parsing unit 430, and the personalization service 440.

Herein, the meaning of including a part or whole is already mentioned. In order to help understanding of the embodiments, including whole, not in part, of a subject will be explained.

The interface 400 includes the user interface and the communication interface. The user interface includes a button unit where a user command is input along with a display, and the communication interface includes a communication module to perform communication. In the process of performing communication, the communication interface can perform conversion of information. According to an exemplary embodiment, encryption/decryption, for example, can be performed additionally. Accordingly, the communication interface may include an encryption/decryption unit. The communication interface can receive the algorithm for encryption and decryption, that is a program, from the service providing apparatus 140 and can store and execute under the control of the controller 420. In this case, as to the algorithm for encryption and decryption, only a part of the algorithm can be stored in an internal memory, that is, the storage 410, according to an exemplary embodiment. In addition, when a part of the rest of the algorithm is provided from the outside, this can be integrated and executed under the control of the controller 420.

The storage 410 matches user information provided by a user of the user apparatus 130 with apparatus information. In addition, the storage 410 can categorize and store user information by the types of the user apparatus 130, and can store or encrypt a part of security information from among user information. Afterwards, the storage 410, when the request for the personalization service is received from the user apparatus 130, can integrate provided security information, match and store them temporarily, and then utilize the stored information.

The controller 420 controls overall operations of the interface 400, the storage 410, the data parsing unit 430, and the personalization service 440 within the image processing apparatus 100. In other words, security information only can be provided from among user information provided from the user apparatus 130, and security information can be extracted, and then security information can be provided to the data parsing unit 430 so that the extracted security information can be parsed to a plurality of security information. Information received in this process can be stored in the storage 410 temporarily. Moreover, the controller 420 can provide encryption or decryption algorithm within the interface 400 to the data parsing unit 430 to perform parsing. Afterwards, the controller 420 can store a part of parsed security information and the parsed algorithm moreover, in the storage 410 and the interface 400, and store the rest in the at least one of the external apparatuses, for example, the user apparatus 130 and the service providing apparatus 140. If, a part of the rest is provided to the user apparatus 130 only, the evidence can be left in the storage 410.

The data parsing unit 430 can be operated under the control of the controller 420, and execute the algorithm for parsing. For example, the data parsing unit 430, among user information, can extract security information and can parse the extracted security information into two or three parts. If intending to store a part of security information in the storage 410, and a part of the rest in the user apparatus 130, the information can be parsed into two, and if intending to store in the service providing apparatus 140 as well, the information can be parsed into three. In addition, the data parsing unit 430, upon request of the controller 420, can parse encryption and/or decryption algorithm. As this algorithm is handled in the same manner as storing and providing the afore-mentioned security information, further explanation will be omitted.

The personalization service unit 440 can provide a service customized to the user apparatus 130. To do this, for example, information can be provided by operating an internal program or application, or provided via link with the external service providing apparatus 140. In other words, the personalization service unit 440, as mentioned before, can perform automatic access to the designated internet site (automatic input of ID and password), adjusting a UI message to suit for a user's age and gender, restoring the same user's last service session, customized advertisement, recommendation, and automatic setting based on pre-stored user's preference, etc. In addition, a customized service can be provided such as adjusting a service scenario based on the specification of the accessed user apparatus 130 or deciding a type of a program on the user apparatus 130 to be executed.

For example, when the image processing apparatus 100 is Bluray optical recording display apparatus, a menu screen such as an interface window can be provided through execution of a program for replaying optical records, for example, JAVA application. Or, in order to provide customized information, for example by running an application to provide information on famous restaurants, information for the personalization service can be provided. Furthermore, an application can be executed so that operations, such as an advertising or a product recommendation can be conducted and provided in linkage with the service providing apparatus 140.

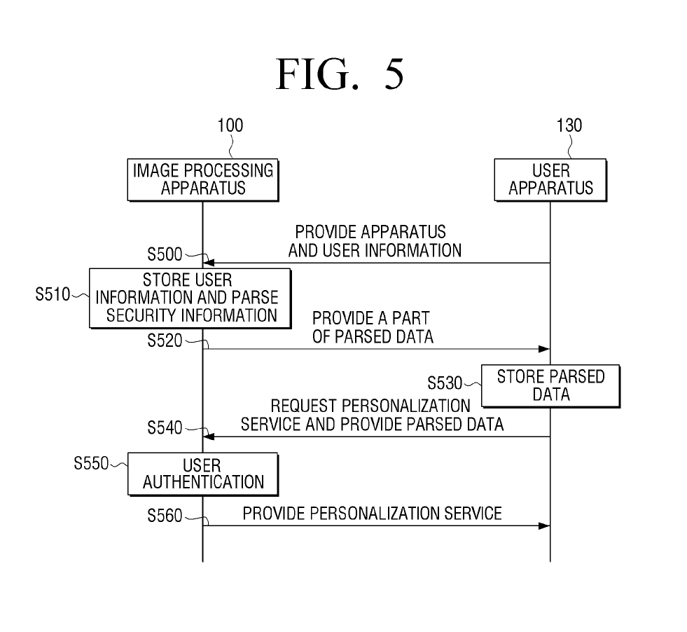

FIG. 5 is a view illustrating a personalization service process according to the first exemplary embodiment. FIG. 5 illustrates the case that the image processing apparatus 100 and the user apparatus 130 only have security information, and moreover encryption and/or decryption algorithm.

Referring to FIG. 5 along with FIG. 1, the image processing apparatus 100 according to an exemplary embodiment receives apparatus information and user information from the user apparatus 130 (S500). For example, the user apparatus 130, when accessing the image processing apparatus 100 for the first time through the short distance wireless communication, may provide user information, such as credit card information, name, age, etc.

The image processing apparatus 100, after matching received user information with apparatus information and storing the information, extracts security information from the stored user information and parses the information (S510). Such operation can be substantially executed, when the image processing apparatus 100 and the user apparatus 130 are disconnected from each other. Herein, the parsed security information can be named or called parsed data.

Thereafter, the image processing apparatus 100 may provide a part of parsed data to the user apparatus 130 (S520), and store a part of the rest in an internal memory.

The user apparatus 130, for example at the time when connection with the image processing apparatus 100 is ended, can receive and store the parsed data provided by the image processing apparatus 100 (S530).

Then, when the user apparatus 130 requests the personalization service again, the user apparatus 130, along with the personalization service, provides the parsing data (more accurately the parsing data with apparatus information) to the image processing apparatus 100 (S540).

And then, the image processing apparatus 100 may incorporate a part of the parsed data stored inside and the rest of the received parsed data, and provide the personalization service to the user apparatus 130 after the user authentication process (S550, S560). In this case, the user authentication process can be automatically executed.

Of course, so far, segregation of security information is explained only, but such security information can be segregated while being encrypted, and algorithm for encryption and/or decryption can also be segregated and provided together. Thus, exemplary embodiments are not limited to the above description.

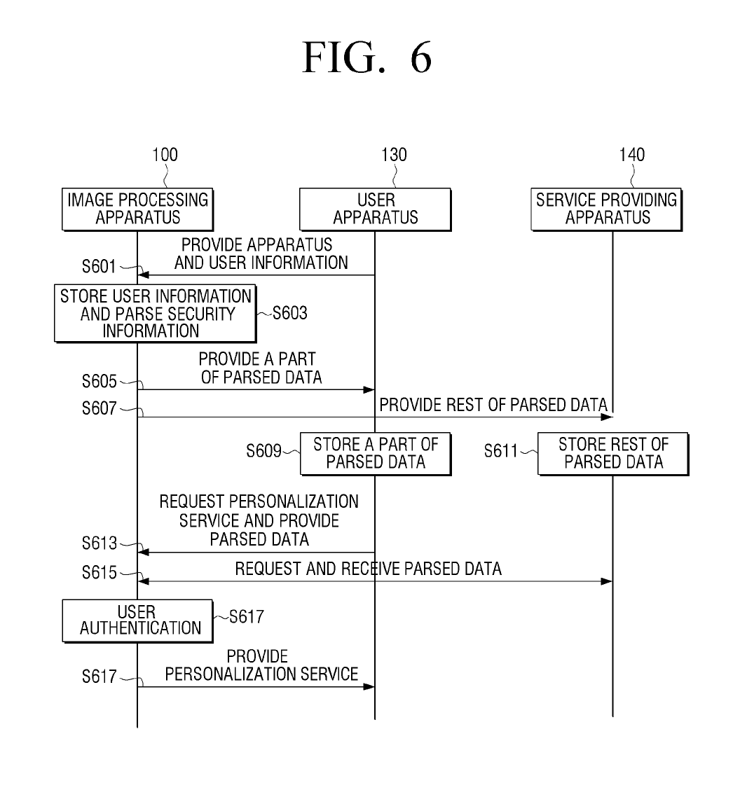

FIG. 6 is a view illustrating a personalization service process according to the second exemplary embodiment. FIG. 6 illustrates the case that security information, moreover, encryption and/or decryption algorithm, are owned by the image processing apparatus 100, the user apparatus 130, and the service providing apparatus 140.

Referring to FIG. 6 along with FIG. 1, the personalization service process according to the exemplary embodiment 2 is not that much different from the personalization service process according to the exemplary embodiment 1 of FIG. 5.

Meanwhile, the image processing apparatus 100, after extracting security information from among received user information, can parse security information into 3 security information according to a preset command such as a user request (S601˜S603). Herein, the preset command includes not only a request by a user but also a setting by a system designer.

Then, the image processing apparatus 100 may provide a part and a part of the rest of the parsed data to the user apparatus 130 and the service providing apparatus 140 respectively and store them, and store another part inside (S607˜S611).

When the user apparatus 130 requests the personalization service, parsed data can be provided from the user apparatus 130 and the service providing apparatus 140 and be incorporated with the stored parsed data inside, and then the personalization service can be provided to the user apparatus 130 after user's authentication (S613˜S619). In this case, authentication can be conducted automatically.

Of course, in the case of the exemplary embodiment 2 referring to FIG. 6, using security information has been explained only, but parsing data can be segregated while security information is encrypted, or encryption and/or decryption algorithm can be segregated together, the exemplary embodiments will not be limited to the above.

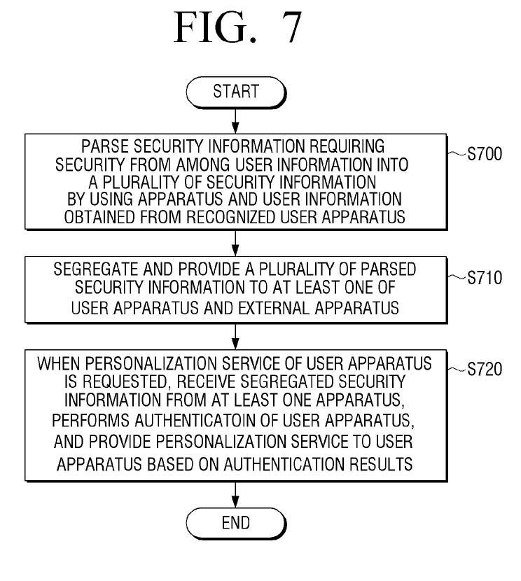

FIG. 7 is a flow chart illustrating a method of providing a personalization service according to an exemplary embodiment.

For convenience of explanation, referring to FIG. 7 along with FIGS. 1 and 4, the image processing apparatus 100 according to an exemplary embodiment extracts security information from user information by using apparatus information and user information obtained from the user apparatus 130 recognized, and parses the extracted security information into a plurality of security information (S700).

Then, the image processing apparatus 100 segregates and provides the parsed plurality of security information to at least one of external apparatus such as the user apparatus 130 and the service providing apparatus 140 (S710).

The afore-mentioned process can be performed in the process when the user apparatus 130 which was connected to the image processing apparatus 100 is disconnected.

Then, when the user apparatus 130 is connected to the image processing apparatus 100 and requests the personalization service, the image processing apparatus 100 may receive the segregated security information from at least one apparatus, perform authentication of the user apparatus 130, and provide the personalization or personalized service to the user apparatus 130 according to authentication result (S720).

In this process, the image processing apparatus 100, ahead of performing authentication, can integrated received security information and segregated security information stored inside, create complete security information, and then perform the authentication process afterwards.

For example, as mentioned above, when security information is segregated after it is encrypted, or algorithm for encryption and/or decryption is segregated and stored, security information, encrypted security information, and segregated algorithm should be integrated to perform normal operations afterwards.

Meanwhile, even though all the elements composing the exemplary embodiments have been explained that they are combined into one or operated in combination, the subject matter is not limited to these exemplary embodiments. That is, within the scope of the embodiments, all the elements can be selectively combined to one or more elements and be operated. In addition, all the elements can be embodied to an independent hardware respectively, but it is also possible that a part or whole of the elements can be selectively combined and be embodied as a computer program which has a program module performing a part or whole functions combined in one or plurality of hardware. The codes and code segments composing the computer program can be easily inferred by those skilled in the art. Such computer program can be stored in a non-transitory computer-readable media, and read and executed by the computer, thereby realizing an exemplary embodiment.

A non-transitory computer-readable medium indicates media which semi-permanently stores data and is readable with an apparatus, not a media which stores data for short time such as register, cache, memory, etc. Specifically, the above-described various applications or programs may be stored and provided in a non-transitory computer-readable medium such as CD, DVD, hard disk, Blue-ray disk, USB, memory card, ROM.

The foregoing embodiments and advantages are merely exemplary and are not to be construed as limiting. The present teaching can be readily applied to other types of apparatuses. Also, the description of the exemplary embodiments of the concept is intended to be illustrative, and not to limit the range of the claims, and many alternatives, modifications, and variations will be apparent to those skilled in the art.

1. An image processing apparatus, comprising:
a data parsing unit configured to, by using apparatus information and user information obtained from a peripheral user apparatus, parse security information requiring security from among the user information into a plurality of parsed security information;
an interface configured to divide and provide the plurality of parsed security information to at least one apparatus among the peripheral user apparatus and an external apparatus; and
a personalization service unit configured to, when a personalization service of the peripheral user apparatus is requested, perform authorization of the peripheral user apparatus by receiving the parsed security information divided and provided from the at least one apparatus, and provide the personalization service to the peripheral user apparatus according to an authorization result.

2. The apparatus as claimed in claim 1, wherein the interface comprises an encoder/decoder which encodes and decodes the parsed security information,
wherein the encoded plurality of parsed security information is encoded security information.

3. The apparatus as claimed in claim 2, wherein the plurality of parsed security information comprises data related to at least one algorithm used for the encoding and decoding.

4. The apparatus as claimed in claim 3, wherein a position of an algorithm for the encoding is found in a file system which manages operations of the personalized service.

5. The apparatus as claimed in claim 1, further comprising:
a storage configured to store a part of the plurality of parsed security information,
wherein a part of the plurality of parsed security information stored in the storage is deleted according to a request of the peripheral user apparatus.

6. The apparatus as claimed in claim 1, wherein the interface is connected to an image display apparatus which displays a content requested by a user,
wherein the apparatus information and the user information are obtainable when the content is displayed on the image display apparatus.

7. A method for providing a personalization service, comprising:
parsing security information requiring security from among user information into a plurality of security information, by using apparatus information and user information obtained from a peripheral user apparatus; and
performing, when a personalization service of the peripheral user apparatus is requested, authorization of the peripheral user apparatus by receiving the security information divided and provided from the at least one apparatus and providing the personalization service to the peripheral user apparatus according to an authorization result.

8. The method as claimed in claim 7, wherein the parsing a plurality of security information comprises encoding and decoding the security information,
wherein the plurality of parsed security information is encoded security information.

9. The method as claimed in claim 8, wherein the plurality of parsed security information comprises data related to at least one algorithm used for the encoding and decoding.

10. The method as claimed in claim 9, wherein a position of an algorithm for the encoding is found by reading and finding information in a file system which manages operations of the personalized service.

11. The method as claimed in claim 9, further comprising:
storing a part of the plurality of parsed security information; and
deleting a part of the plurality of parsed security information stored in the storage according to a request of the user apparatus.

12. The method as claimed in claim 7, wherein the apparatus information and the user information are obtainable when the content is displayed on an image display apparatus.

13. In a non-transitory computer-readable medium to execute a method for providing a personalization service, comprising:
parsing security information requiring security from among user information to a plurality of security information, by using apparatus information and user information obtained from a peripheral user apparatus;
dividing and providing the parsed plurality of security information to at least one apparatus among the peripheral user apparatus and an external apparatus; and
performing, when a personalization service of the peripheral user apparatus is requested, authorization of the user apparatus by receiving the security information divided and provided from the at least one apparatus and providing the personalization service to the peripheral user apparatus according to an authorization result.

14. A method for providing a personalization service, comprising:
dividing user security information into at least first and second parts;
storing the first part in a user apparatus and storing the second part in a external apparatus; and
providing, by a service providing server, a personalized service to the user apparatus using the first and second parts obtained from the user apparatus and the external apparatus.

15. A method as claimed in claim 14, wherein the first and second parts are combined to obtain authorization to provide the service.

16. A method as claimed in claim 15, wherein authorization is obtained using information of the user apparatus.

17. A method as claimed in claim 14, further comprising encrypting the first and second parts.

18. A method as claimed in claim 17, wherein a first encryption algorithm for the first part is stored in the user apparatus and a second encryption algorithm for the second part is stored in the external apparatus.

19. A method as claimed in claim 14, wherein the personalized service is a product recommendation and the security information is a user profile.

20. A method as claimed in claim 14, wherein the external apparatus comprises an image processing apparatus.
